(19) United States
(12) Patent Application Publication
(10) Pub. No.: US 2007/0038572 A1
(43) Pub. Date: Feb. 15, 2007

(54) Method, system and computer program for metering software usage

(75) Inventors: Bernardo Pastorelli, L'Aquila (IT); Peter J. Relson, Ulster Park, NY (US); Carl E. Clark, Poughkeepsie, NY (US)

Correspondence Address: Kenneth R. Corsello;IBM Corporation, MS P386, 2455 South Road, Poughkeepsie, NY, 12601, US

(73) Assignee: International Business Machines Corporation, Armonk, NY (US)

(21) Appl. No.: 11/199,905

(22) Filed: Aug. 9, 2005

(51) Int. Cl. G06Q 99/00

(52) U.S. Cl. 705/52

(57) ABSTRACT

A method and system for metering usage of software products on a data processing system. Requests to load an executable module are monitored and, if it is determined that a request was received to load an executable module, a metering flag is checked for the executable module that is indicative of whether the executable module is an executable module that is to be metered. If the metering flag indicates that the executable module is to be metered, a software product associated with the executable module is identified.

### FIELD OF THE INVENTION

The present invention relates to the data processing field. More specifically, the present invention relates to the metering of usage of software products on a data processing system.

### BACKGROUND

Software products (such as computer programs) can be perfectly reproduced in an infinite number of copies. This is a major concern for vendors of the products wishing to protect their intellectual property rights (since any unaccounted use of the products results in unpaid royalties). The problem has been exacerbated in the last years by the widespread diffusion of the Internet, which further facilitates the uncontrolled distribution of this type of products.

In this respect, a number of licensing applications are available on the market (such as the “Tivoli License Manager”, or TLM, by IBM Corporation). Those tools facilitate the task of metering the usage of selected products (especially in complex environments) . For this purpose, a licensing application detects the executable modules that are running on the system; for example, this result is achieved by periodically determining the executable modules associated with the active processes or by intercepting the launch of any new executable module.

In any case, the licensing application must identify the product associated with each (detected) executable module. A well established technique is to use a software catalogue. The software catalogue lists all the products of interest. Each product is associated with one or more executable modules, which indicate the usage of the product when running.

However, the process of matching each executable module against the software catalogue is relatively time consuming. Indeed, this operation is typically based on multiple attributes of the executable module (such its name, size and checksum), in order to ensure a higher degree of accuracy and to allow discriminating different versions of the same product (typically having executable modules with the same name). Moreover, the time required for searching the executable module in the software catalogue increases with its length. This drawback is particular acute in distributed environments, wherein a high number of products must be metered.

As a result, the process of identifying the products in use on the system involves a substantial waste of time. This waste of time may be acceptable on small systems (such as Personal Computers), where the launching rate of new executable modules is quite low (for example, one every 5-10 minutes). However, the waste of time is unacceptable on large systems (for example, mainframes such as the “zSeries” machines by IBM Corporation); indeed, in this case thousands of new executable modules are launched every second. Therefore, it is very difficult (if not impossible) to complete the identification process in an acceptable timeframe.

In any case, the licensing application should not adversely affect the performance of the underlying application software products running on the system. For this purpose, the consumption of processing resources by the licensing application should be maintained within an acceptable range (for example, below 1-2%).

In order to limit the overheard of the system, it is possible to log the detection of the executable modules only. In this way, the identification process can be performed off-line when the workload of the system is lower (for example, at the end of the day). However, this solution does not allow metering the usage of the software products in real-time, and it is not possible to prevent the running of any unauthorized product.

### SUMMARY OF THE INVENTION

The present invention proposes a solution that is based on the idea of preventing the execution of operations that are not necessary.

Particularly, an aspect of the invention proposes a method for metering usage of software products on a data processing system. In an example embodiment, the method involves monitoring the loading of executable modules (for example, by detecting when the loading of each executable module is requested or by periodically listing the loaded executable modules). The method may continue by accessing a descriptor of each executable module (such as its directory entry) that stores information for the loading. A metering flag included in the descriptor (indicative of the necessity of metering the executable module) may be checked. In response to the assertion of the metering flag, a software product associated with the executable module may be identified.

In an embodiment of the invention, the metering flags are asserted during a scan of the system (e.g., a scan for each executable module matching an entry of a software catalogue listing the products to be metered). In addition or in alternative, the metering flags may be set when the corresponding products are installed.

Typically, the proposed solution is used in combination with a licensing application. Each executable module may be always loaded when the metering flag is deasserted, or otherwise may be loaded only when its running is authorized.

A suggested implementation of the invention is based on a kernel extension which interfaces with the licensing application. The kernel extension may intercept any request to load an executable module and pass this request to the operating system if it is necessary. Alternatively, in a different implementation the operating system itself checks the metering flag and invokes the licensing application (registered as a user exit) when the metering flag is asserted. In both cases, similar operations are performed when the executable module must be unloaded, so as to release a corresponding license assigned to it (if necessary).

Another aspect of the present invention proposes a system and/or computer program corresponding to the method. The characterizing features of the present invention are set forth in the appended claims. Further features of the invention may be understood by reference to the following detailed description, given purely by way of a nonrestrictive indication, to be read in conjunction with the accompanying drawings.

### BRIEF DESCRIPTION OF THE DRAWINGS

FIG. 1a is a schematic block diagram of a data processing system in which an embodiment of the invention is applicable;

FIG. 1b shows the functional blocks of an exemplary computer of the system;

FIG. 2 depicts the main software components that can be used for implementing an embodiment of the invention;

FIGS. 3a-3c show a diagram describing the flow of activities relating to an implementation of an embodiment of the invention;

FIG. 4 depicts the main software components that can be used for implementing a further embodiment of the invention; and

FIGS. 5a-5c show a diagram describing the flow of activities relating to an implementation of the further embodiment of the invention of FIG. 4.

### DETAILED DESCRIPTION

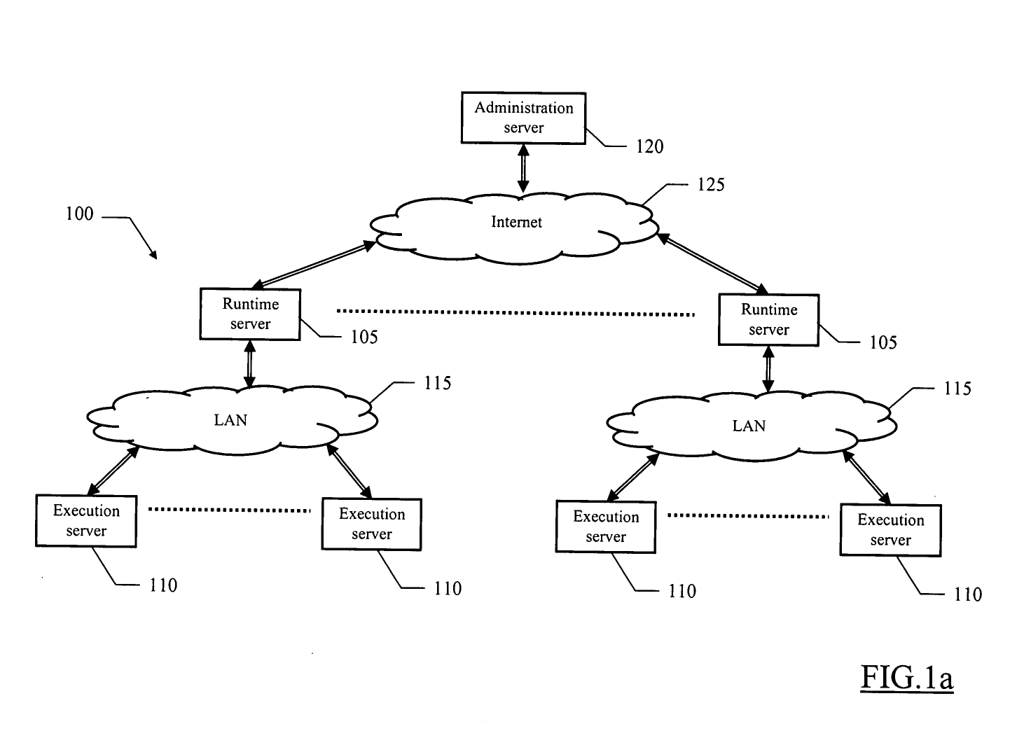

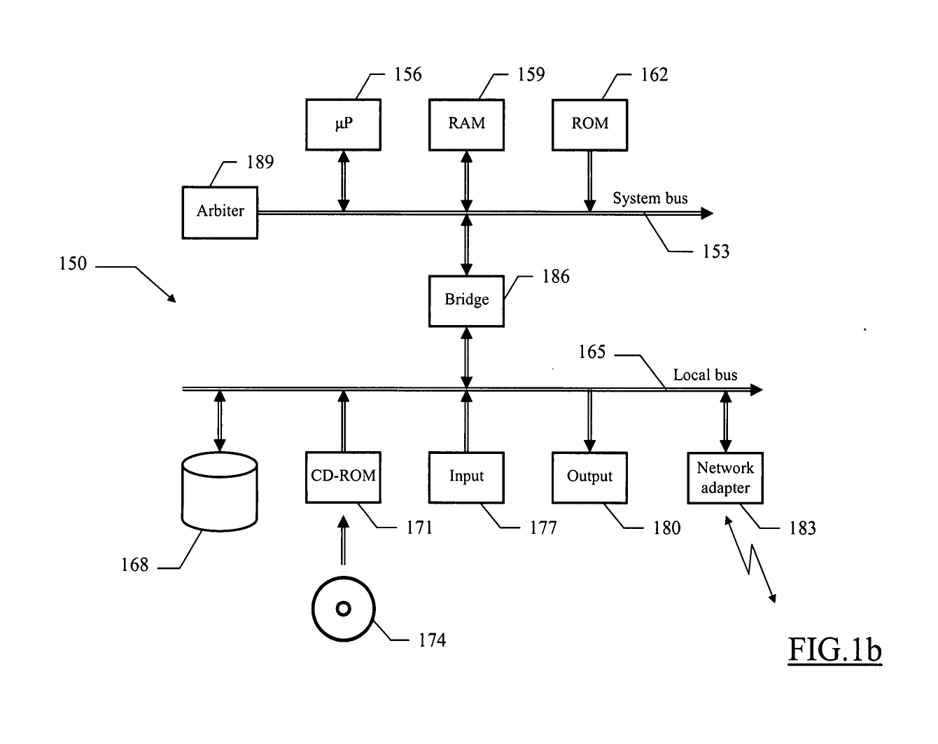

FIG. 1a is a schematic block diagram of a data processing system in which an embodiment of the invention is applicable. A data processing system 100 with distributed architecture is depicted. The system 100 implements a license management infrastructure (for example, based on the above-mentioned TLM), which allows controlling the usage of selected software products (such as computer programs). The system 100 includes one or more independent organizations (only one shown in the figure), which are completely separate and distinct from each other. Within the organization, one or more divisions are defined. Each division is formed by a runtime server, shown as runtime servers 105, which directly controls the usage of assigned products on a set of corresponding execution servers (or nodes) 110. For this purpose, the division's runtime server 105 and all the execution servers 110 of the division communicate through a network (for example, a LAN 115). The different runtime servers 105 may report to a single administration server 120, which may implement a central control point for inventory, procurement, and usage information of the whole organization. As shown, the runtime servers 105 and the administration server 120 may be connected to a different network 125 (for example, INTERNET-based).

Considering now FIG. 1b, one embodiment of a generic computer of the system (e.g., runtime server, execution server or administration server) is denoted with 150. The computer 150 is formed by several units that are connected in parallel to a system bus 153. In detail, one or more microprocessors (μP) 156 control operation of the computer 150; a RAM 159 is directly used as a working memory by the microprocessors 156, and a ROM 162 stores basic code for a bootstrap of the computer 150. Several peripheral units are clustered around a local bus 165 (by means of respective interfaces). Particularly, a mass memory consists of one or more hard-disks 168 and drives 171 for reading CD-ROMs 174. Moreover, the computer 150 includes input units 177 (for example, a keyboard and a mouse), and output units 180 (for example, a monitor and a printer). A network adapter 183 is used to plug the computer 150 into the system 100 of FIG. 1a. A bridge unit 186 interfaces the system bus 153 with the local bus 165. Each microprocessor 156 and the bridge unit 186 can operate as master agents requesting an access to the system bus 153 for transmitting information. An arbiter 189 manages the granting of the access with mutual exclusion to the system bus 153.

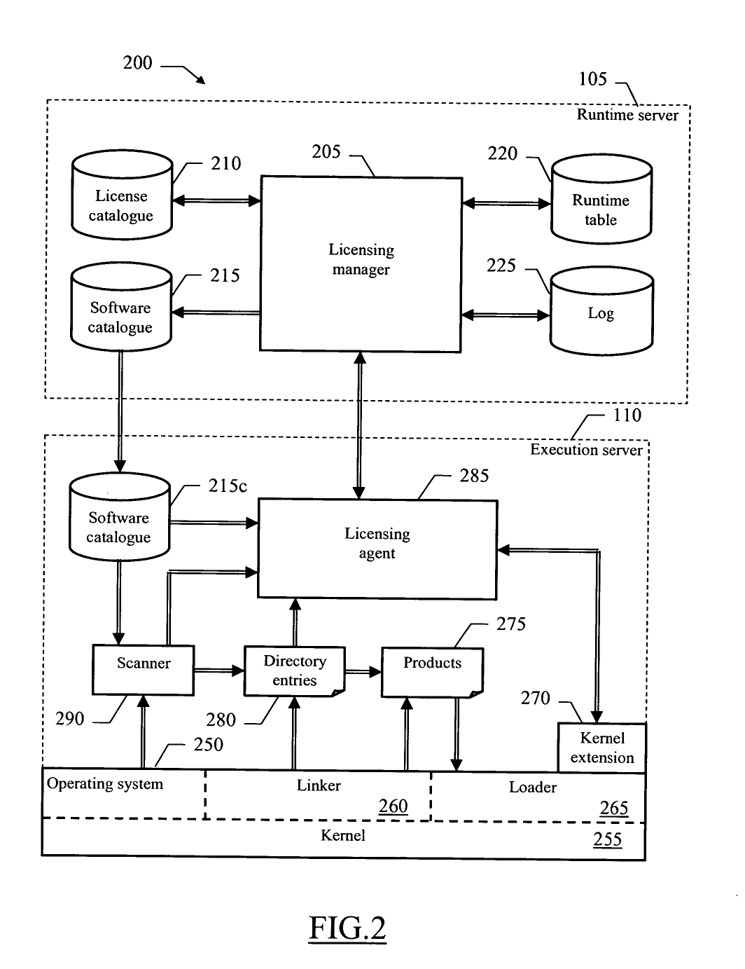

Moving to FIG. 2, the main software components that may be used to implement an embodiment of the invention are denoted as a whole with the reference 200. The information (programs and data) is typically stored on the hard-disk and loaded (at least partially) into the working memory of each computer when the programs are running. The programs may be initially installed onto the hard-disk, for example, from CD-ROM.

Considering in particular the runtime server 105 of a generic division, its core module may consist of a licensing manager 205. This module 205 accesses a license catalogue 210, which stores a predefined number of electronic licenses for each product authorized to run in the division. Each license defines a usage right of the product, which enables an execution server to run the corresponding product when assigned to it. In addition, the license may specify any kind of authorized conditions of use of the product set by its vendor (such as the maximum processing power of the execution servers on which the product is allowed to run).

The licensing manager 205 may also control a software catalogue 215, which lists all the known products to be metered in the organization. Each product is identified by a signature defined by one or more executable modules, which indicate the usage of the product when running; typically, each executable module is specified in the software catalogue 215 by means of multiple attributes (such as its name, size and checksum).

In addition, the licensing. manager 205 may own a runtime table 220, which tracks the products currently in use in the division. The licensing manager 205 may also collect information from the corresponding execution servers (for example, about the installed products, any attempts to use non-authorized or unknown products, and the like); this information may be stored into a corresponding log 225.

The license catalogue 210 and the software catalogue 215 may be downloaded on the runtime server 105 from the administration server (for example, periodically or at any change thereof). Likewise, the runtime server 105 may periodically upload the log 225 to the administration server (for example, at the end of every day).

Considering now a generic execution server 110 of the same division, an operating system 250 (such as the “zOS” by IBM Corporation) provides a software platform on top of which any application program may run. The main module of the operating system 250 may consist of a kernel 255, which implements all the essential services required by any other parts thereof. For example, a linker 260 may be used to generate an executable module from one or more object code components. Typically, the linker combines different components that have been compiled separately, embeds libraries providing standard functions, resolves symbolic references to external objects, relocates the code according to its actual address space, and the like. On the other hand, a loader 265 finds a required executable module on the hard-disk, loads it in into the working memory (relocating the code when necessary), and then launches its execution. In an embodiment of the invention, a kernel extension 270 is also added to the operating system 250; the kernel extension 270 may implement further functionalities by using publicly available, standard interfaces. Particularly, the kernel extension 270 may be used to perform the operations required by the proposed solution without the necessity of modifying the operating system 250.

One or more products 275 are installed on the execution server 110. Each product 275 typically includes a main executable module used for its launching and auxiliary executable modules called during the running (all of them generated by the linker 260 at the installation time), text files with help messages, control files providing configuration information, databases storing production data, and the like. The different components of the product 275 represent corresponding nodes of a tree defined by a file system of the execution server 110 (supported by the operating system 250). Each file is associated with a corresponding directory entry 280. The directory entry 280 may store the name of the file, a pointer to its first cluster (along the chain defining the corresponding content), and various attributes thereof; typical attributes of the file include its access permission (such as read only, hidden, or system reserved), the type of the file (such as program or archive), information for its loading, the creation, last access and last modification date/time, its size and checksum, and the like.

According to an embodiment of the invention, a licensing agent 285 (continually running in the background) interfaces with the licensing manager 205 for controlling the usage of the products 275 installed on the execution server 110. Normally, the kernel extension 270 intercepts any request (submitted to the operating system 250) of loading a desired executable module on the execution server 110 (by means of a so-called hooking technique). The kernel extension 270 may then send a notification of the event to the licensing agent 285. In turn, the licensing agent 285 may try to identify the corresponding product 275 (which running has been requested). For this purpose, the licensing agent 285 may extract the attributes of the executable module from the corresponding directory entry 280; those attributes may be compared with the content of a copy of the software catalogue (denoted with 215c), which is downloaded from the licensing server 105 (for example, periodically or at any change thereof). The information so obtained may be transmitted by the licensing agent 285 to the licensing manager 205, which may determine whether to grant or deny an authorization to run the product (according to the content of the license catalogue 210 and of the running table 220). The result of the operation may be stored into the log 225 and be returned to the licensing agent 285 (updating the running table 220 if necessary); accordingly, the licensing agent 285 (through the kernel extension 270) enables or prevents the loader's 265 launching of the product 275.

In addition, the execution server 110 may also include a scanner module 290, which may be used to scan the hard-disk of the execution server 110 (through corresponding services provided by the operating system 250) and may identify all the products 275 installed on the execution server 110 that are listed in the software catalogue 215c. The information so obtained may be passed to the licensing agent 285, which in turn transmits it to the licensing manager 205 (for storing into the log 225).

It has been observed in prior systems that most of the products 275 that are installed on the execution server 110 are often not included in the software catalogue 215c (since the products to be metered usually consist of a quite small set). Nevertheless, in many cases it is only discovered that an executable module is not of interest after the whole software catalogue 215c has been scanned without finding any match. This process involves a substantial waste of time and the logging of a massive amount of data (for every missing match) that overloads the execution server 110 uselessly.

Therefore, in an embodiment of the present invention the directory entry 280 of each executable module is extended with the addition of a metering flag (i.e., one bit), which indicates whether the running of the executable module must be metered. As described in detail in the following, the metering flags are set by the scanner 290 or by the linker 260 when the corresponding products 275 are installed. In this way, for any executable module that is to be loaded, the above-described process of identifying the corresponding product and verifying its authorization to run is executed only if the associated metering flag is asserted (i.e., if the running of the product is actually to be metered). Conversely (if the metering flag is deasserted) the executable module is launched without performing any additional operation.

As a consequence, for the executable modules that are not of interest (i.e., most modules) only a few operations are performed to determine that they are not to be metered; in this way, it is possible to avoid wasting time and logging data uselessly. Conversely, the (time consuming) process of identifying the corresponding product and verifying its authorization to run is performed only when it is really necessary (the rarest cases). It should be noted that this result is achieved basically without any overhead of the execution server 110. Indeed, the operating system 250 has to access the directory entry 280 of the executable module in any case for its launching (and the operation of checking the corresponding metering flag only requires a few simple instructions).

In this way, it is possible to reduce the time that is spent for the process on the whole, or vice-versa it is possible to dedicate more time to the metering of the products of interest (thereby increasing the accuracy of the results).

Moreover, the proposed solution facilitates maintaining the consumption of processing resources by the licensing agent 285 within an acceptable range (for example, below 1-2%). This ensures that the licensing agent 285 does not adversely affect the performance of the products 275 running on the execution server 110. This advantage is clearly perceived in large computers (such as mainframes), wherein the rate of launching new executable modules is very high (of the order of thousands every second).

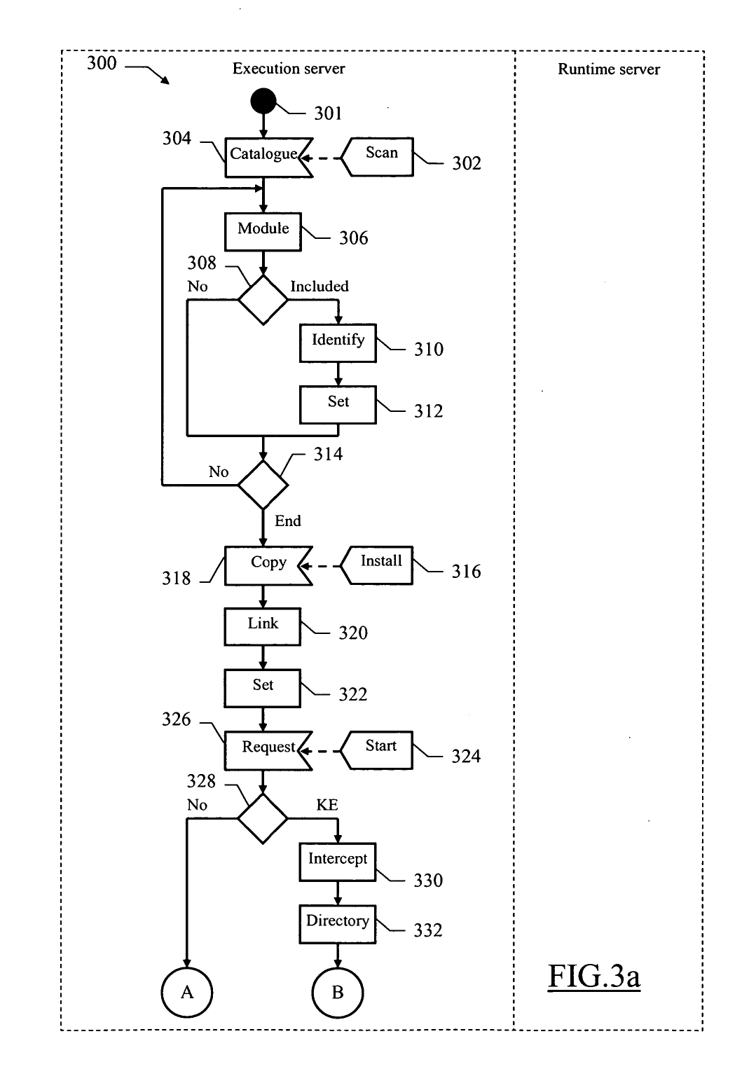

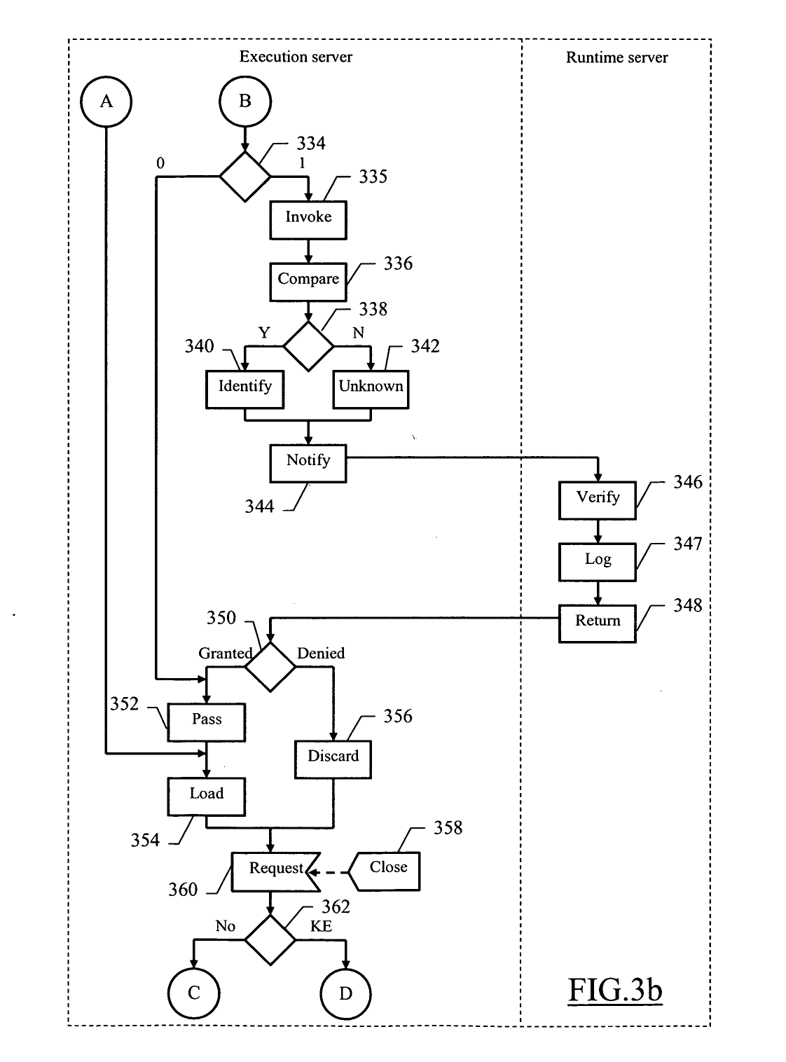

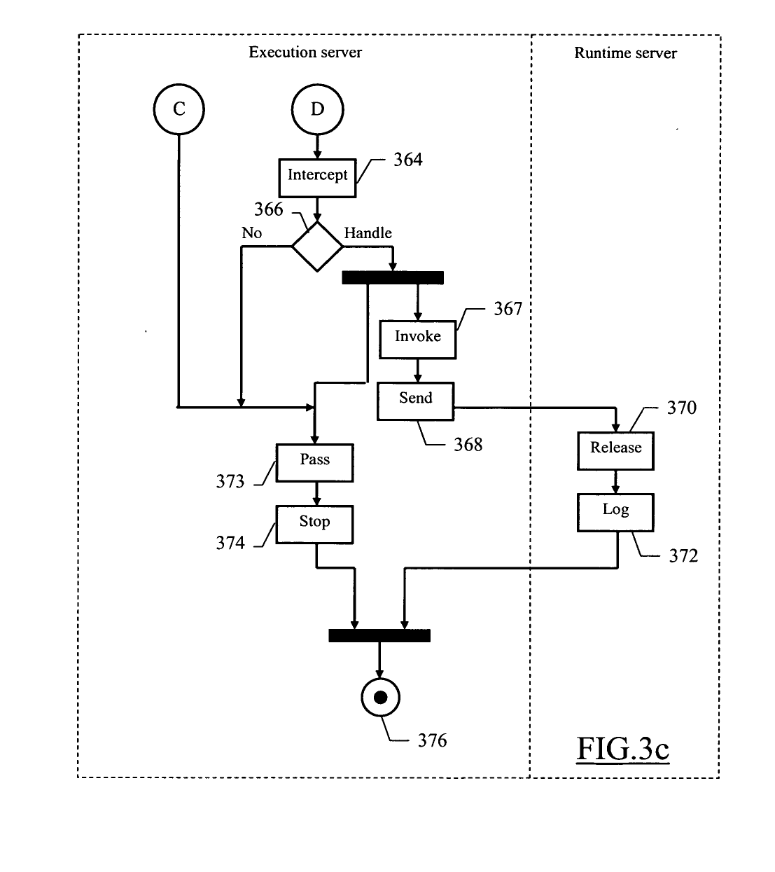

Moving now to FIGS. 3a-3c, the logic flow of an exemplary process that can be implemented in the above-described system (for metering the usage of desired products) is represented with a method 300. The method 300 begins at the black start circle 301 in the swim-lane of a generic execution server. If a scan of its hard-disk is requested at block 302 (for example, if a new software catalogue is downloaded from the runtime server, or a predetermined time-out expires), the process is initialized at block 304 by loading the software catalogue. The method 300 then continues to block 306, wherein the whole tree of the file system is traversed top-down (starting from a root directory); whenever a leaf node is reached, the corresponding directory entry is accessed so as to extract the attributes of the corresponding file (the type and then the name, size and checksum in the example at issue).

Whenever an executable module is found (as indicated by its type), a test is made at block 308 to verify whether the executable module is included in the software catalogue. If so, the corresponding product indicated in the software catalogue is identified at block 310 (and added to a list of products installed on the execution server). Continuing to block 312, the metering flag in the corresponding directory entry is asserted (to indicate that the running of the executable module must be metered). The flow of activity then descends into block 314; the same point is also reached from block 308 directly when the name of the module is not included in the software catalogue or its attributes do not match the ones specified in the entry of the software catalogue for the same name. If further nodes of the tree of the file system remain to be analyzed, the flow of activity returns to block 306 for continuing the scanning of the hard-disk. It should be noted that the overhead caused by the setting of the metering flags is very low. Indeed, the directory entry of every file has to be accessed in any case during the scanning (to understand whether the file is an executable module and to extract its attributes if so); moreover, only a few directory entries (i.e., the ones of the executable modules found in the software catalogue) must be updated by asserting their metering flags.

Once the scanning of the hard-disk has been completed, whenever a new product is to be installed on the execution server (block 316) the method passes to block 318; in this phase, the relevant components of the product are copied onto the hard-disk (typically, under the control of an installation wizard). Proceeding to block 320, the installation wizard invokes the linker for generating each required executable module dynamically (with the corresponding directory entry). The linker has been customized to accept a metering parameter, which may be set by the installation wizard so as to force the linker to assert the corresponding metering flag at block 322. In this way, the execution of any product can be metered (even if it is not included in the software catalogue). The desired result, is achieved with a very simple modification to the product; indeed, it is necessary to add a further parameter in the invocation of the linker only (by the installation wizard), without any need to change the code of the product. As a result, the effort for future testing of the product after the modification is very limited.

Considering now block 324, whenever the start of a product installed on the execution server is required (for example, by its user or by another program) a request to load the corresponding main executable module is submitted at block 326 to the loader of the operating system. The flow of activity then branches at decision block 328. If the kernel extension is running, the loading request is intercepted by this module at block 330. Continuing to block 332, the kernel extension accesses the corresponding directory entry. A test is now made at block 334 on the metering flag that is extracted from the directory entry, as shown in FIG. 3b.

If the metering flag is asserted, the kernel extension at block 335 invokes the licensing agent (by passing the attributes of the executable module extracted from its directory entry). The metering agent at block 336 compares the size and the checksum of the executable module with the ones specified in the entry of the software catalogue for its name (if any). When the attributes of the executable module match the ones indicated in the software catalogue (decision block 338), the corresponding product is identified at block 340. Conversely, if there is not a match, the product is set as unknown at block 342 (saving any available information thereof).

In both cases, the information so obtained is notified to the runtime server at block 344. In response thereto, the licensing manager at block 346 verifies whether the execution of the identified product on the execution server can be authorized (i.e., whether one or more corresponding licenses are available and the environment of the execution server meets the authorized configuration); on the other hand, any unknown product is deemed non-authorized by default (or the administrator is prompted to define its authorization at run-time). If the product is authorized to run, a license for the product is assigned to the execution server updating the running table accordingly; at the same time, a handle identifying the assigned license is associated thereto. In any case, the result of the verification is logged at block 347; in this phase, it is also possible to notify any critical condition to the administration server (for example, when the number of the available licenses for the product falls below a threshold value). A corresponding response (i.e., the handle of the license or a refusal code) is returned to the execution server at block 348.

The licensing agent relays the response to the kernel extension, which checks it at block 350 (at the same time, saving the handle in association with the executable module when applicable). If the authorization to run has been granted, the kernel extension at block 352 passes the loading request to the operating system; the same point is also reached from block 334 directly when the metering flag is deasserted (to indicate that the running of the executable module is not be metered). The executable module is then loaded as usual at block 354; the same operation is also performed when the kernel extension is not running (from block 328). Conversely, if the authorization to run has been denied, the method passes from block 350 to block 356, wherein the loading request is discarded (thereby preventing the launching of the executable module).

Considering now block 358, whenever an executable module running on the execution server is to be closed, the flow of activity passes to block 360; in this phase, a corresponding request of unloading the executable module is submitted to the loader of the operating system. The flow of activity then branches at decision block 362. If the kernel extension is running, this module at block 364 intercepts the unloading request, as shown in FIG. 3C. Continuing to block 366, the kernel extension verifies whether a handle (identifying a corresponding license) is associated with the executable module. If so, the kernel extension at block 367 invokes the licensing agent (by passing the handle). The licensing agent in turn sends this handle to the runtime server at block 368. In response thereto, the licensing manager at block 370 releases the corresponding license (updating the running table accordingly). The operation is also logged at block 372. Returning to the swim-lane of the execution server, at the same time the kernel extension in any case descends from block 366 into block 373, wherein the unloading request is passed to the operating system; the same point is also reached directly from block 362 when the kernel extension is not running. The method 300 then continues to block 374, wherein the process associated with the executable module is closed as usual. The flow of activity joins (from blocks 372 and 374) at the concentric white/black stop circles 376.

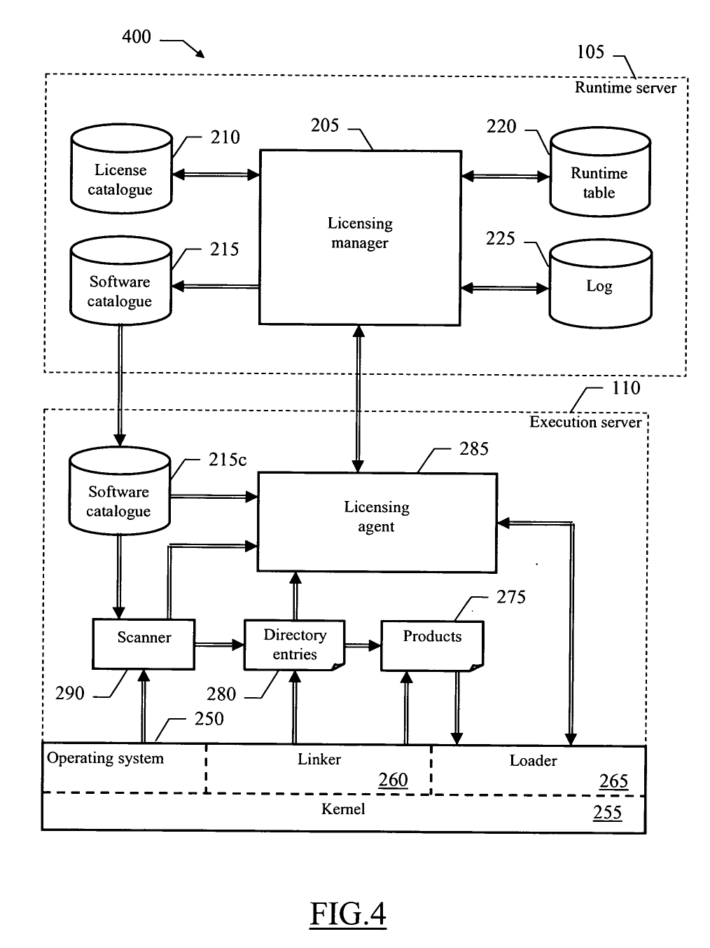

In a different embodiment of the invention, as shown in FIG. 4, the main software components that can be used for implementing the proposed solution are denoted as a whole with 400; the elements corresponding to the ones shown in the FIG. 2 are indicated with the same references, and their explanation will be omitted for the sake of brevity.

Particularly, this implementation differs in that no kernel extension is now required. On the other hand, the licensing agent 285 is registered as a user exit with the loader 265. A user exit generally consists of a predefined access point in a program for the invocation of tailor-made external routines; in this way, it is possible to customize the program without the need to change its code. As in the preceding case, the licensing agent 285 manages the identification of the products to be executed and the verification of their authorization to run. The loader 265 has instead been customized for recognizing the metering flags in the directory entries 280 of the executable modules to be launched, so as to call the licensing agent 285 when it is necessary.

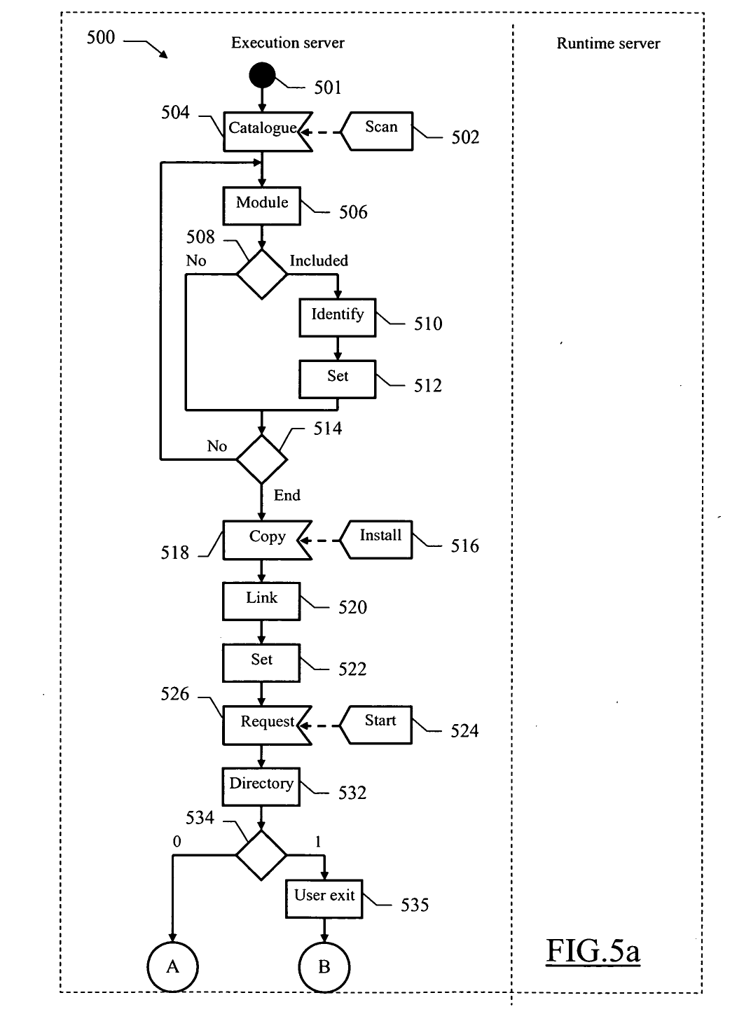

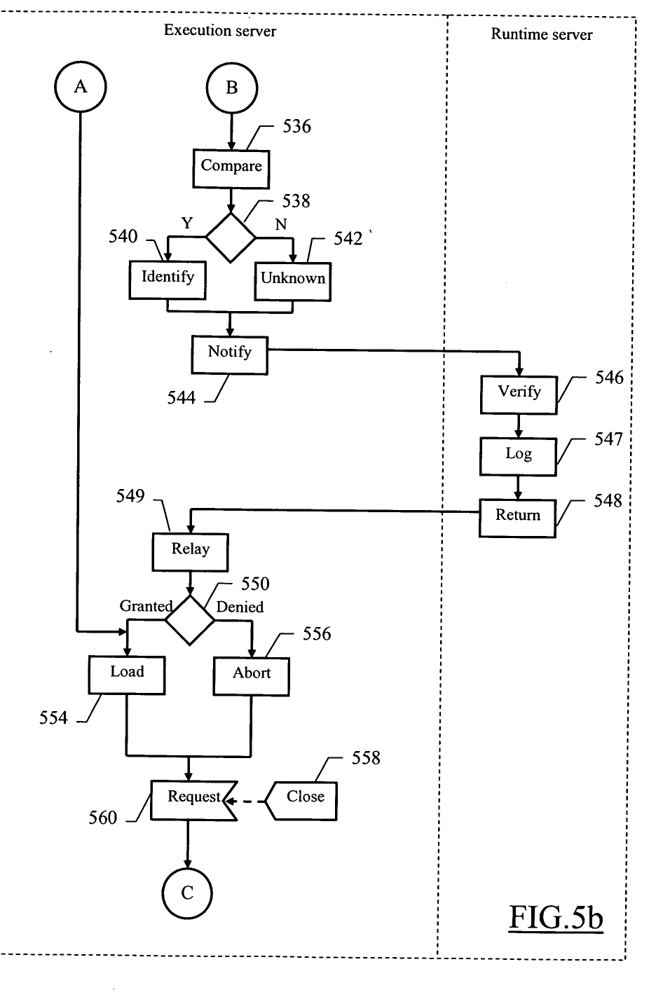

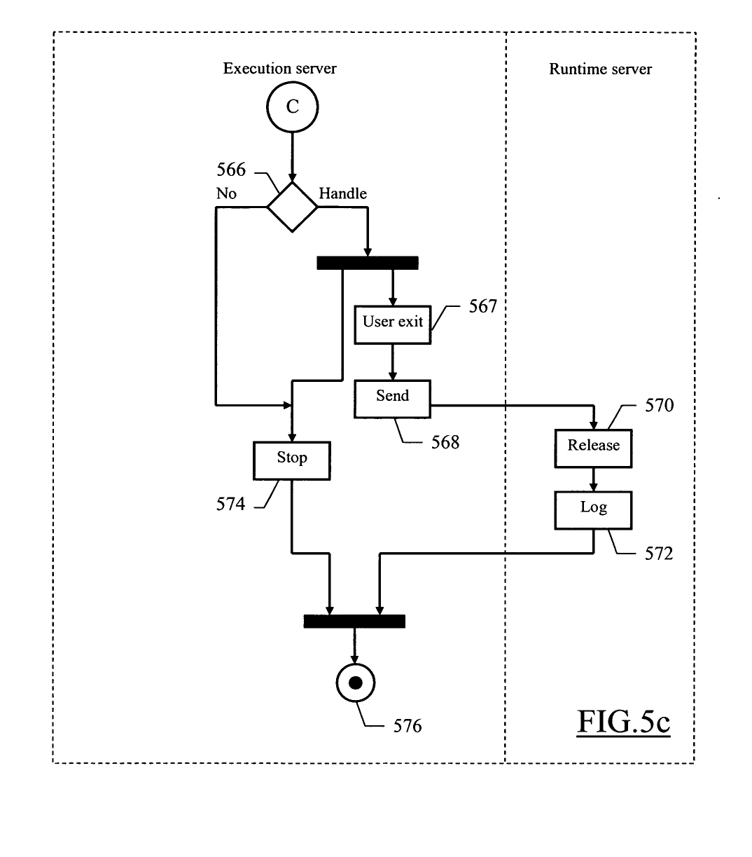

More in detail, as shown in FIGS. 5a-5c, a corresponding activity diagram implements a method 500. The blocks 501-526 of the method 500 (relating to the setting of the metering flags in the directory entries during the scanning of the hard-disk and at the installation time of the products) are exactly the same as the blocks 301-326 of the preceding case. From block 526 (when a request of loading any executable module is submitted to the operating system), the flow of activity now passes to block 532; in this case, the loader immediately accesses the directory entry of the executable module. A test is now made at block 534 on the metering flag that is extracted from the directory entry.

If the metering flag is asserted, the loader at block 535 calls the user exit associated with the licensing agent (by passing the required information about the executable module, i.e., its name, size and checksum). As described above, the product is identified (if possible) and a corresponding authorization to run is requested to the runtime server (see blocks 536-548, corresponding to the blocks 336-348 of the preceding case).

As shown in FIG. 5b, the licensing agent at block 549 relays the response (i.e., the handle of the license or the refusal code) to the loader (which saves the handle in association with the executable module when applicable). In response thereto, the loader at block 550 verifies whether the authorization to run has been granted. If so, the executable module is loaded as usual at block 554; the same point is also reached from block 534 directly when the metering flag is deasserted (and then no user exit is called). Conversely, the loading request is aborted at block 556 (thereby preventing the launching of the executable module).

Whenever an executable module running on the execution server is to be closed (block 558) and a corresponding unloading request is submitted to the operating system (block 560), the loader itself at block 566 verifies whether a handle (identifying a corresponding license) is associated with the executable module. If so, the loader at block 567 calls again the user exit associated with the licensing agent by passing this handle, as shown in FIG. 5C. As described above, the corresponding license is released (see blocks 568-572 corresponding to the blocks 368-372 of the preceding case). At the same time, the flow of activity in any case descends from block 566 to block 574, wherein the loader closes the process associated with the executable module as usual. The method 500 then ends (from blocks 572 and 574) at the concentric white/black stop circles 576.

Naturally, in order to satisfy local and specific requirements, a person skilled in the art may apply to the solution described above many modifications and alterations. Particularly, although the present invention has been described with a certain degree of particularity with reference to preferred embodiment(s) thereof, it should be understood that various omissions, substitutions and changes in the form and details as well as other embodiments are possible; moreover, it is expressly intended that specific elements and/or method steps described in connection with any disclosed embodiment of the invention may be incorporated in any other embodiment as a general matter of design choice.

For example, similar considerations apply if the system has a different architecture or includes equivalent units. Moreover, each computer may have another structure or may include similar elements (such as cache memories temporarily storing the programs or parts thereof to reduce the accesses to the mass memory during execution); in any case, it is possible to replace the computer with any code execution entity (such as a PDA, a mobile phone, and the like).

It should be readily apparent that the implementation of the present invention is not limited to any specific licensing application and/or technique for identifying the products launched or in use on the execution servers.

Without departing from the principles of the invention, the same concepts may be applied to control the usage of audio and video recordings, electronic books, multimedia works, video games, or any other software (i.e., digitally encoded) products. This result may be achieved by monitoring the loading of any kind of executable modules (for example, DLLs not running in a dedicated process).

The proposed technical idea may be applied to any other operating system, which implements a file system supporting a structure corresponding to the above-described directory entry, or more generally providing any descriptor of each executable module that stores information for its loading; likewise, the bit representing the metering flag may be replaced with any equivalent element included in the directory entry.

Similar considerations apply if the software catalogue provides any other information useful for associating the software products to be metered with the corresponding executable module(s), or if it is replaced with any equivalent physical or logical structure. Alternatively, the use of any other technique for scanning the mass memory of the execution servers is within the scope of the invention (for example, only matching the name of the executable modules against the software catalogue).

Moreover, nothing prevents setting the metering flags under the control of the installation wizards directly, or modifying the code of the products accordingly.

In any case, it is possible to assert the metering flags only during the scan of the hard-disk or only during the installation of the products; moreover, any other technique for setting the metering flags is contemplated (for example, in response to a specific command).

Alternatively, the products are always allowed to start (for example, logging an exception when their usage is not authorized). Moreover, the application of the proposed solution in a context different from the licensing management is contemplated. Particularly, the information that has been collected about the products can be used for reporting purposes only (without any verification of their authorizations to run).

Even though in the preceding description reference has been made to two exemplary methods for checking the metering flags (i.e., based on the kernel extension and on the user exit), this is not to be intended as a limitation. Indeed, the principles of the invention find equal application to other scenarios; for example, it is possible to obtain a list of the executable modules associated with the active processes periodically, and then identify the products associated with the executable modules having the corresponding metering flags asserted only.

Similar considerations apply if the program (which may be used to implement the invention) is structured in a different way, or if additional modules or functions are provided; likewise, the memory structures may be of other types, or may be replaced with equivalent entities (not necessarily consisting of physical storage media). Moreover, the proposed solution lends itself to be implemented with an equivalent method (for example, having similar or additional steps). In any case, the program may take any form suitable to be used by or in connection with any data processing system, such as external or resident software, firmware, or microcode (either in object code or in source code). Moreover, the program may be embodied on any computer-usable medium; the medium can be any element suitable to contain, store, communicate, propagate, or transfer the program. Examples of such medium are fixed disks (where the program can be pre-loaded), removable disks, tapes, cards, wires, fibers, wireless connections, networks, broadcast waves, and the like; for example, the medium may be of the electronic, magnetic, optical, electromagnetic, infrared, or semiconductor type).

In any case, the present invention lends itself to be carried out with a hardware structure (for example, integrated in a chip of semiconductor material), or with a combination of software and hardware.

What is claimed is:

1. A method for metering usage of software products in a data processing system, the method comprising:
monitoring for a request to load an executable module;
if based on the monitoring it is determined that a request was received to load an executable module, checking a metering flag for the executable module that is indicative of whether the executable module is an executable module that is to be metered; and
if the metering flag indicates that the executable module is to be metered, identifying a software product associated with the executable module.

2. The method according to claim 1, further comprising:
if the metering flag indicates that the executable module is to be metered, determining whether the software product is authorized to be run; and
if the software product is authorized to be run or if the metering flag indicates that the executable module is not to be metered, loading the executable module.

3. The method according to claim 2, wherein the request to load an executable module is addressed to an operating system of the data processing system and is intercepted by a kernel extension of the operating system, wherein the kernel extension performs the step of checking the metering flag, wherein a licensing application is invoked by the kernel extension to perform the steps of identifying a software product and determining whether the software product is authorized to run, and wherein the kernel extension passes the request to load the module to the operating system if the software product is authorized to be run or if the metering flag indicates that the executable module is not to be metered.

4. The method according to claim 3, further comprising:
assigning a usage right of the software product to the executable module in response to the positive authorization to run, wherein the usage right is assigned by the licensing application;
intercepting at the kernel extension a request to unload the executable module, wherein the request is addressed to the operating system;
passing the request to unload from the kernel extension to the operating system, the operating system unloading the executable module in response to the request to unload; and
invoking the licensing application for the kernel extension to release the usage right.

5. The method according to claim 2, further comprising:
receiving the request to load the executable module at an operating system of the data processing system, wherein the operating system performs the step of checking a metering flag;
if the metering flag indicates that the executable module is to be metered, invoking a licensing application from the operating system in response to the assertion of the metering flag, wherein the licensing application performs the steps of identifying a software product and determining whether the software product is authorized to be run; and
returning an indication of the authorization to be run from the licensing application to the operating system, the operating system loading the executable module in response to a positive authorization to run.

6. The method according to claim 5, further comprising:
in response to the positive authorization to run, assigning a usage right of the software product to the executable module;
receiving a request to unload the executable module, the operating system unloading the executable module in response to the request to unload;
verifying the assignment by the operating system of the usage right to the executable module; and
in response to a positive verification of the assignment, invoking the licensing application for the kernel extension to release the usage right.

7. A computer program product including a computer-usable medium embodying a computer program, the computer program when executed on a data processing system causing the system to perform the steps of:
monitoring for a request to load an executable module;
if based on the monitoring it is determined that a request was received to load an executable module, checking a metering flag for the executable module that is indicative of the whether the executable module is an executable module that is to be metered; and
if the metering flag indicates that the executable module is to be metered, identifying a software product associated with the executable module.

8. The computer program product of claim 7, wherein the computer program when executed causing the system to further perform the steps of:
if the metering flag indicates that the executable module is to be metered, determining whether the software product is authorized to be run; and
if the software product is authorized to be run or if the metering flag indicates that the executable module is not to be metered, loading the executable module.

9. The computer program product of claim 8, wherein the request to load an executable module is to be addressed to an operating system of the data processing system and is to be intercepted by a kernel extension of the operating system, wherein the kernel extension is to perform the step of checking the metering flag, wherein a licensing application is to be invoked by the kernel extension to perform the steps of identifying a software product and determining whether the software product is authorized to run, and wherein the kernel extension is to pass the request to load the module to the operating system if the software product is authorized to be run or if the metering flag indicates that the executable module is not to be metered.

10. The computer program product of claim 9, wherein the computer program when executed causing the system to further perform the steps of:
assigning a usage right of the software product to the executable module in response to the positive authorization to run, wherein the usage right is assigned by the licensing application;
intercepting at the kernel extension a request to unload the executable module, wherein the request is addressed to the operating system;
passing the request to unload from the kernel extension to the operating system;
verifying in the kernel extension the assignment of the usage right to the executable module; and
in response to a positive verification of the assignment, invoking the licensing application for the kernel extension to release the usage right.

11. The computer program product of claim 8, wherein the request to load the executable module is received at an operating system of the data processing system, the operating system performing the step of checking a metering flag, and wherein the computer program when executed causing the system to further perform the steps of:
if the metering flag indicates that the executable module is to be metered, invoking a licensing application from the operating system in response to the assertion of the metering flag, wherein the licensing application performs the steps of identifying a software product and determining whether the software product is authorized to be run; and
returning an indication of the authorization to be run from the licensing application to the operating system, the operating system loading the executable module in response to a positive authorization to run.

12. The computer program product of claim 11, wherein the computer program when executed causing the system to further perform the steps of:
in response to the positive authorization to run, assigning a usage right of the software product to the executable module;
receiving a request to unload the executable module, the operating system unloading the executable module in response to the request to unload;
verifying the assignment by the operating system of the usage right to the executable module; and
in response to a positive verification of the assignment, invoking the licensing application for the kernel extension to release the usage right.

13. The computer program product of claim 7, wherein the computer-usable medium embodying a computer program when executed on a data processing system to cause the system to further perform the steps of:
providing a software catalogue including an indication of a set of selected software products to be metered, the software catalogue associating each selected software product with at least one corresponding selected executable module;
determining a set of installed executable modules being installed on the system; and
asserting the metering flag in the descriptor of each installed executable module corresponding to one of the selected executable modules.

14. The computer program product of claim 13, wherein the computer-usable medium embodying a computer program when executed on a data processing system to cause the system to further perform the steps of:
installing a further selected software product to be metered, the further selected software product including at least one further selected executable module, wherein the metering flag in the descriptor of each further selected executable module is asserted during the installation.

15. A system for metering usage of software products on a data processing system, the system comprising:
a first module that is embodied on a computer-usable medium on the data processing system for monitoring the loading of executable modules, for accessing a descriptor of each executable module storing information related to such loading, and for checking a metering flag included in the descriptor, the metering flag being indicative of whether usage of the executable module is to be metered; and
a licensing agent embodied at the data processing system for identifying a software product associated with the executable module if the metering flag indicates that the executable module is to be metered.

16. The system according to claim 15, wherein the system further comprises an operating system embodied at the data processing system, and wherein the first module is a kernel extension of the operating system.

17. The system according to claim 15, wherein the system further comprises an operating system embodied at the data processing system, and wherein the first module is a loader.

18. The system according to claim 15, wherein the system further comprises a software catalogue embodied at the data processing system to contain a list of software products.

19. The system according to claim 18, wherein the system further comprises a scanner embodied at the data processing system to scan a memory of the data processing system and identify products installed on the data processing system that are listed in the software catalogue.
